(19) United States
(12) Patent Application Publication
(10) Pub. No.: US 2023/0390902 A1
(43) Pub. Date: Dec. 7, 2023

(54) POWERED RATCHET WRENCH

(71) Applicant: Raymond Leroy Black, Jr., Duncansville, PA (US)

(72) Inventor: Raymond Leroy Black, Jr., Duncansville, PA (US)

(21) Appl. No.: 17/830,686

(22) Filed: Jun. 2, 2022

(51) Int. Cl. B25B 21/00; B25F 5/00; B25F 5/02; F21V 33/00

(52) U.S. Cl. CPC B25B 21/004; B25F 5/001; B25F 5/02; F21V 33/0084

(57) ABSTRACT

A powered ratchet wrench, including a handle body to facilitate gripping thereof, a wrench head attachment removably connected within at least a portion of the handle body, the wrench head attachment including a head body, and a wrench aperture disposed on and within at least a portion of the head body to removably connect to at least one of a nut and a bolt, and a control unit disposed on at least a portion of the handle body to move the wrench aperture in a first rotational direction or a second rotational direction opposite to the first rotational direction.

### BACKGROUND

### 1. Field

The present general inventive concept relates generally to a wrench, and particularly, to a powered ratchet wrench.

### 2. Description of the Related Art

Some projects, such as construction and/or maintenance of a vehicle and/or a building require tightening and/or loosening of bolts and nuts that are seated in deep and tight places. In such situations, it can be very difficult for a person to access the bolt and/or nut as well as apply adequate force to tighten and/or loosen the bolt and/or the nut.

Moreover, the person performing the work will often switch and/or replace their wrenches. As such, the person must carry multiple wrenches with different shapes and/or sizes to tackle every job. The necessity of carrying multiple wrenches is tiresome due to the weight of having so many.

Therefore, there is a need for a powered ratchet wrench that has an adjustable wrench head.

### SUMMARY

The present general inventive concept provides a powered ratchet wrench.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a powered ratchet wrench, including a handle body to facilitate gripping thereof, a wrench head attachment removably connected within at least a portion of the handle body, the wrench head attachment including a head body, and a wrench aperture disposed on and within at least a portion of the head body to removably connect to at least one of a nut and a bolt, and a control unit disposed on at least a portion of the handle body to move the wrench aperture in a first rotational direction or a second rotational direction opposite to the first rotational direction.

The wrench head attachment may further include an aperture gear circumferentially disposed around a perimeter of the wrench aperture to move the wrench aperture, and a connecting gear disposed within at least a portion of the head body to move the aperture gear in response to being moved.

The powered ratchet wrench may further include a motorized assembly disposed within at least a portion of the handle body to move the wrench aperture.

The powered ratchet wrench may further include a locking pin removably connected within the head body to prevent the head body from being extracted from the handle body while disposed within the handle body.

The powered ratchet wrench may further include a sliding lock movably disposed on at least a portion of the handle body to prevent the head body from moving away from the handle body in a first position and allow the head body to move away from the handle body in a second position.

The powered ratchet wrench may further include a light disposed on at least a portion of the handle body to illuminate a surrounding area of the handle body.

The wrench aperture may increase in rotation speed in response to depressing at least one of a first directional button and a second directional button of the control unit further within the handle body with respect to an outer surface of the handle body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a powered ratchet wrench, according to an exemplary embodiment of the present general inventive concept; and

FIG. 2 illustrates a side perspective view of a wrench head attachment, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Powered Ratchet Wrench 100
Handle Body 110
Wrench Head Attachment 120
Head Body 121
Wrench Aperture 122
Aperture Gear 123
Connecting Gear 124
Pin Receiving Aperture 125
Motorized Assembly 130
Power Gear 131
Motor 132
Locking Pin 140
Sliding Lock 150
Light 160
Control Unit 170
First Directional Button 171
Second Directional Button 172
Power Switch 180
Power Source 190

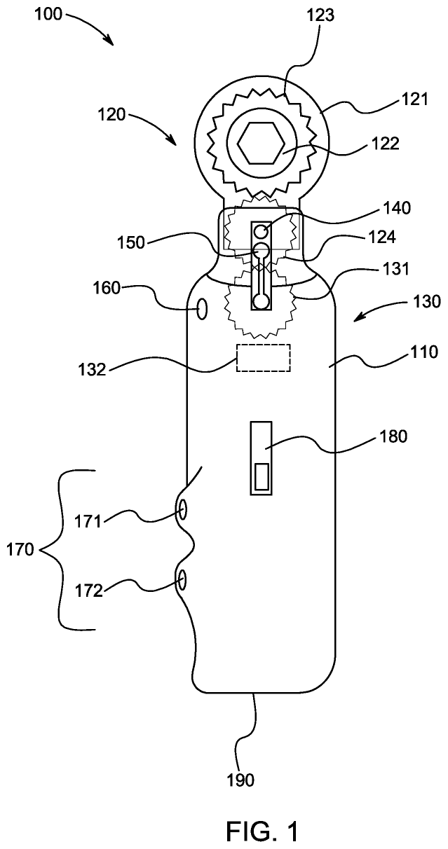

FIG. 1 illustrates a side perspective view of a powered ratchet wrench 100, according to an exemplary embodiment of the present general inventive concept.

The powered ratchet wrench 100 may be constructed from at least one of metal, plastic, wood, and rubber, etc., but is not limited thereto.

The powered ratchet wrench 100 may include a handle body 110, a wrench head attachment 120, a motorized assembly 130, a locking pin 140, a sliding lock 150, a light 160, a control unit 170, a power switch 180, and a power source 190, but is not limited thereto.

The handle body 110 may have a predetermined size based on portability. In other words, the handle body 110 may have a size to facilitate being hand-held. The handle body 110 may facilitate gripping thereof.

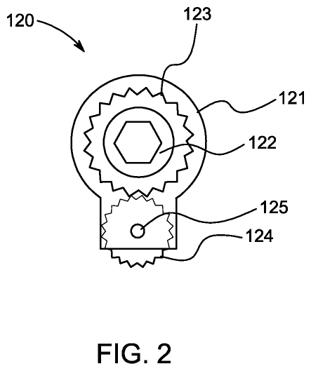

FIG. 2 illustrates a side perspective view of a wrench head attachment 120, according to an exemplary embodiment of the present general inventive concept.

The wrench head attachment 120 may include a head body 121, a wrench aperture 122, an aperture gear 123, a connecting gear 124, and a pin receiving aperture 125, but is not limited thereto.

The head body 121 may be removably connected to at least a portion of the handle body 110. More specifically, the head body 121 may be inserted within the handle body 110.

Referring to FIGS. 1 and 2, the head body 121 is illustrated to have a circular shape. However, the head body 121 may be rectangular, spherical, cylindrical, triangular, pentagonal, hexagonal, heptagonal, octagonal, or any other shape known to one of ordinary skill in the art, but is not limited thereto. As such, the head body 121 may be shaped based on a type of wrench.

The wrench aperture 122 may also be known as a wrench jaw. The wrench aperture 122 may be disposed on and/or within at least a portion of the head body 121. The wrench aperture 122 may have a shape (e.g., circular, triangular, pentagonal, hexagonal, heptagonal, octagonal) and/or a size (e.g., dimensions) according to a shape and/or a size of a nut and/or a bolt. Accordingly, the wrench aperture 122 may be removably connected to the nut and/or the bolt. In other words, the wrench aperture 122 may receive the nut and/or the bolt therein.

Furthermore, the wrench aperture 122 may be constructed based on the shape and/or the size of the nut and/or the bolt. Thus, another wrench head attachment 120 may exchange and/or replace the wrench head attachment 120 to be connected to the handle body 110 for a different nut and/or bolt. Therefore, the wrench head attachment 120 facilitates work for a user by eliminating the need to carry multiple wrenches.

The aperture gear 123 may be circumferentially disposed around a perimeter of the wrench aperture 122 within the head body 121. The wrench aperture 122 may move (i.e., rotate) in response to rotation of the aperture gear 123.

The connecting gear 124 may be disposed within at least a portion of the head body 121 and/or connected to the aperture gear 123. However, the connecting gear 124 may at least partially protrude from the head body 121 to an exterior environment. The aperture gear 123 may move (i.e., rotate) in response to rotation of the connecting gear 124.

The pin receiving aperture 125 may be disposed on and/or within at least a portion of the head body 121.

The motorized assembly 130 may include a power gear 131 and a motor 132, but is not limited thereto.

The power gear 131 may be disposed within at least a portion of the handle body 110. The power gear 131 may removably connect (i.e. attach) to the connecting gear 124 in response to inserting the head body 121 into the handle body 110.

The motor 132 may be disposed within at least a portion of the handle body 110 and/or connected to the power gear 131. The power gear 131 may move (i.e., rotate) in response to rotation of the motor 132. Accordingly, the wrench aperture 122 may move in response to rotation of the motor 132 while the power gear 131 is connected to the connecting gear 124.

The locking pin 140 may be removably connected within the pin receiving aperture 125. The locking pin 140 may prevent the head body 121 from being extracted and/or moving away from the handle body 110 while disposed within the pin receiving aperture 125.

The sliding lock 150 may be movably (i.e., slidably) disposed on at least a portion of the handle body 110. For example, the sliding lock 150 may engage a clamp within the handle body 110 to tighten around the head body 121 in response to moving to a first position and loosen away from the head body 121 in response to moving to a second position different from the first position. As such, the sliding lock 150 may prevent the head body 121 from moving away from the handle body 110 independent of use of the locking pin 140. Thus, the locking pin 140 and/or the sliding lock 150 may be a fail-safe for each other.

Accordingly, the head body 121 may be removed from the handle body 110 in response to extracting the locking pin 140 from the pin receiving aperture 125 and/or moving the sliding lock 150 to the second position.

The light 160 may be disposed on at least a portion of the handle body 110. The light 160 may illuminate a surrounding area of the handle body 110 in response to turning on.

The control unit 170 may include a first directional button 171 and a second directional button 172, but is not limited thereto.

The first directional button 171 and/or the second directional button 172 may be disposed on at least a portion of the handle body 110 and/or connected to the motorized assembly 130. Additionally, the first directional button 171 and/or the second directional button 172 may at least partially protrude away from a surface of the handle body 110 to facilitate access to each. The first directional button 171 may move (i.e., rotate) the aperture gear 123 via the motor 132 in a first rotational direction (i.e., clockwise) in response to being depressed. Conversely, the second directional button 172 may move (i.e., rotate) the aperture gear 123 via the motor 132 in a second rotational direction (i.e., counterclockwise) in response to being depressed. As such, the first directional button 171 and/or the second directional button 172 may control a direction of rotation of the aperture gear 123.

Furthermore, the aperture gear 123 via the motor 132 may increase in rotation speed in response to depressing the first directional button 171 and/or the second directional button 172 harder (e.g., depressed further in the handle body 110). In other words, the further within the handle body 110 the first directional button 171 and/or the second directional button 172 are depressed with respect to an outer surface of the handle body 110, the faster the aperture gear 123 may rotate.

The power switch 180 may be disposed on at least a portion of the handle body 110. The power switch 180 may turn on the motorized assembly 120, the light 160, and/or the control unit 170 in response to being depressed a first time. Conversely, the power switch 180 may turn off the motorized assembly 120, the light 160, and/or the control unit 170 in response to being depressed a second time.

Also, the power switch 180 may have multiple settings. For example, the power switch 180 may be moved to a first position to turn on the light only, a second position to turn on the motorized assembly 120, the light 160, and/or the control unit 170, and/or a third position to turn on the motorized assembly 120 and/or the control unit 170 without the light 160.

The power source 190 may include a battery and a solar cell, but is not limited thereto.

The power source 190 may be disposed within at least a portion of the handle body 110. The power source 190 may provide power to the motorized assembly 120, the light 160, the control unit 170, and/or the power switch 180.

Therefore, the powered ratchet wrench 100 may facilitate tightening and/or loosening the bolt and/or the nut without having to require manual movements by the user. Also, the powered ratchet wrench 100 may be customized with different wrench head attachments 120, such that the user does not have to carry multiple wrenches.

The present general inventive concept may include a powered ratchet wrench 100, including a handle body 110 to facilitate gripping thereof, a wrench head attachment 120 removably connected within at least a portion of the handle body 110, the wrench head attachment 120 including a head body 121, and a wrench aperture 122 disposed on and within at least a portion of the head body 121 to removably connect to at least one of a nut and a bolt, and a control unit 170 disposed on at least a portion of the handle body 110 to move the wrench aperture 122 in a first rotational direction or a second rotational direction opposite to the first rotational direction.

The wrench head attachment 120 may further include an aperture gear 123 circumferentially disposed around a perimeter of the wrench aperture 122 to move the wrench aperture 122, and a connecting gear 124 disposed within at least a portion of the head body 121 to move the aperture gear 123 in response to being moved.

The powered ratchet wrench 100 may further include a motorized assembly 130 disposed within at least a portion of the handle body 110 to move the wrench aperture 122.

The powered ratchet wrench 100 may further include a locking pin 140 removably connected within the head body 121 to prevent the head body 121 from being extracted from the handle body 110 while disposed within the handle body 110.

The powered ratchet wrench 100 may further include a sliding lock 150 movably disposed on at least a portion of the handle body 110 to prevent the head body 121 from moving away from the handle body 110 in a first position and allow the head body 121 to move away from the handle body 110 in a second position.

The powered ratchet wrench 100 may further include a light 160 disposed on at least a portion of the handle body 110 to illuminate a surrounding area of the handle body 110.

The wrench aperture 122 may increase in rotation speed in response to depressing at least one of a first directional button 171 and a second directional button 172 of the control unit 170 further within the handle body 110 with respect to an outer surface of the handle body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A powered ratchet wrench, comprising:
a handle body to facilitate gripping thereof;
a wrench head attachment removably connected within at least a portion of the handle body, the wrench head attachment comprising:
a head body, and
a wrench aperture disposed on and within at least a portion of the head body to removably connect to at least one of a nut and a bolt; and
a control unit disposed on at least a portion of the handle body to move the wrench aperture in a first rotational direction or a second rotational direction opposite to the first rotational direction.

2. The powered ratchet wrench of claim 1, wherein the wrench head attachment further comprises:
an aperture gear circumferentially disposed around a perimeter of the wrench aperture to move the wrench aperture; and
a connecting gear disposed within at least a portion of the head body to move the aperture gear in response to being moved.

3. The powered ratchet wrench of claim 1, further comprising:
a motorized assembly disposed within at least a portion of the handle body to move the wrench aperture.

4. The powered ratchet wrench of claim 1, further comprising:
a locking pin removably connected within the head body to prevent the head body from being extracted from the handle body while disposed within the handle body.

5. The powered ratchet wrench of claim 1, further comprising:
a sliding lock movably disposed on at least a portion of the handle body to prevent the head body from moving away from the handle body in a first position and allow the head body to move away from the handle body in a second position.

6. The powered ratchet wrench of claim 1, further comprising:
a light disposed on at least a portion of the handle body to illuminate a surrounding area of the handle body.

7. The powered ratchet wrench of claim 1, wherein the wrench aperture increases in rotation speed in response to depressing at least one of a first directional button and a second directional button of the control unit further within the handle body with respect to an outer surface of the handle body.
